(19) United States
(12) Patent Application Publication
(10) Pub. No.: US 2023/0104403 A1
(43) Pub. Date: Apr. 6, 2023

(54) INTELLIGENT VEHICLE NAVIGATION SYSTEMS AND CONTROL LOGIC FOR DRIVING INCIDENT DETECTION IN LOW/NO CONNECTIVITY AREAS

(71) Applicant: GM GLOBAL TECHNOLOGY OPERATIONS LLC, Detroit, MI (US)

(72) Inventors: Ravid Erez, Hod-Hashron (IL); Ariel Telpaz, Givat Haim Meuhad (IL); Nadav Baron, Herzliya (IL); Barak Hershkovitz, Even Yehuda (IL); Dima Zevelev, Yavne (IL); Hesham Yassin, Arraba (IL); Amit B. Carmeli, Netanya (IL); Erez Yahalomi, Hod Hasharon (IL)

(73) Assignee: GM GLOBAL TECHNOLOGY OPERATIONS LLC, Detroit, MI (US)

(21) Appl. No.: 17/493,881

(22) Filed: Oct. 5, 2021

(51) Int. Cl. G08B 25/10; G05B 13/02; G01C 21/36; G07C 5/08; G08B 21/18

(52) U.S. Cl. CPC G08B 25/10; G05B 13/0265; G01C 21/36; G07C 5/0808; G08B 21/182; G07C 5/008

(57) ABSTRACT

A method for controlling operation of an intelligent vehicle navigation (IVN) system includes a system controller receiving path plan data for a desired route of a vehicle and, using this path plan data, identifying a low/no-connectivity (LNC) area with limited/no wireless service within the desired route. The IVN system retrieves historical trip data containing time durations to cross the LNC area for a statistically significant number of prior trips across the LNC area; the IVN system constructs a probability distribution of these trip durations. The IVN system tracks a time lapse during which no wireless signal is received from the vehicle after output of the vehicle's last wireless signal before entering the LNC area. A driving incident is predicted responsive to the no-signal time lapse exceeding a predefined threshold within the probability distribution. The system controller responds to the predicted driving incident by transmitting an alert to a third-party entity.

### INTRODUCTION

The present disclosure relates generally to navigation systems for motor vehicles. More specifically, aspects of this disclosure relate to intelligent vehicle navigation systems and control logic for detecting emergency issues in low/no-connectivity areas.

Current production motor vehicles, such as the modern-day automobile, may be equipped with a network of onboard electronic devices and wireless communications capabilities that provide automated driving capabilities and navigation assistance. As vehicle processing, communication, and sensing capabilities improve, manufacturers persist in offering more automated driving capabilities with the aspiration of producing fully autonomous “self-driving” vehicles competent to navigate among heterogeneous vehicle types in both urban and rural scenarios. Original equipment manufacturers (OEM) are moving towards vehicle-to-vehicle (V2V) and vehicle-to-infrastructure (V2I) “talking” cars with higher-level driving automation that employ autonomous control systems to enable vehicle routing with steering, lane changing, scenario planning, etc. Automated path planning systems, for example, utilize vehicle state and dynamics sensors, geolocation information, map and road condition data, and path prediction algorithms to provide route derivation with automated lane center and lane change forecasting.

Many automobiles are now equipped with in-vehicle computer navigation systems that utilize a global positioning system (GPS) transceiver in cooperation with navigation software and geolocation mapping services to obtain roadway topography, traffic, and speed limit data associated with the vehicle's current location. Ad-hoc-network-based driver assistance systems, for example, may employ GPS and mapping data in conjunction with multi-hop geocast V2V and V2I data exchanges to facilitate automated vehicle maneuvering and powertrain control. During vehicle operation, the resident navigation system may identify a recommended travel route based on an estimated shortest travel time or estimated shortest travel distance between route origin and route destination for a given trip. This recommended travel route may then be displayed as a map trace or as turn-by-turn driving directions on a geocoded and annotated map with optional voice commands output by the in-vehicle audio system.

### SUMMARY

Presented herein are intelligent vehicle navigation systems with attendant control logic for driving incident detection and remediation in low/no-connectivity (LNC) areas, methods for making and methods for operating such systems, and motor vehicles networking with such systems. By way of example, a controller-executable algorithm detects off-road emergency issues using mobile connectivity behavior of the host vehicle and historical driving data for an LNC area. A driving incident may be predicted by identifying a remote off-road track that a driver plans to cross, employing data on mobile network coverage along this track, and tracing a mobile signal output from the host vehicle when entering/exiting the track. Based on historical data accumulated during previous trips on this track, the system derives an expected duration of time it should take for a vehicle to cross each LNC segment along the track. From this expected duration, the system anticipates a time frame in which the vehicle's mobile signal should resume, indicating that the vehicle is out of the LNC area. If the vehicle does not return a signal within a first predefined threshold in the anticipated timeframe (e.g., within two standard deviations of a mean exit time on a gaussian distribution), the system generates an alert to a designated contact person. An automated emergency message may also be sent to local authorities if the vehicle does not return a signal within a second predefined threshold (e.g., within three standard deviations of the mean exit time). The thresholds for these notifications may be based on real-time or predicted battery state data at entry into the LNC area.

Attendant benefits for at least some of the disclosed concepts include intelligent vehicle navigation systems that accurately detect driving incidents in LNC areas, such as a breakdown or rollover incident on an off-road track or remote roadway. Disclosed techniques may also account for time of day, weather, user-defined activities, user driving history, vehicle make/model, etc., to more accurately estimate the predicted time to cross an LNC area. In addition, herein-described intelligent navigation systems make allowances for vehicle battery state to determine a size of a time delay interval to inform contact personnel/local authorities for a more comprehensive evaluation of potential vehicle driving incidents. To obviate false positives, the system may continually monitor, aggregate, and evaluate historical trip data for off-road and low-connectivity paths to forecast accurate expected exit times to cross through the LNC area(s).

Aspects of this disclosure are directed to system control logic, closed-loop feedback control techniques, and computer-readable media (CRM) for manufacturing and/or using a navigation system for a host vehicle. In an example, a method is presented for controlling operation of an intelligent vehicle navigation system. This representative method includes, in any order and in any combination with any of the above and below disclosed options and features: receiving, e.g., via a resident or remote system controller from an in-vehicle telematics unit, smartphone, navigation transceiver, or GPS-based satellite service, path plan data indicative of a desired route for the motor vehicle (e.g., origin, destination, and/or predicted path); identifying, e.g., via the system controller from a memory-stored map database, one or more LNC areas with limited/no wireless connectivity within the desired route; receiving historical trip data that contains the time durations to cross each LNC area for a statistically significant number of prior trips across that LNC area; determining a probability distribution of the trip durations for each LNC area; tracking a no-signal time lapse—period of time in which no signal is received from the host—after output of the last wireless signal by the motor vehicle prior to/during vehicle entry into an LNC area; predicting occurrence of a driving incident, such as a mechanical or electrical failure, responsive to the no-signal time lapse exceeding a predefined threshold within the probability distribution of trip durations; and transmitting, e.g., via the system controller responsive to predicting the occurrence of the driving incident, an alert to a remote computing node of a third-party entity.

Additional aspects of this disclosure are directed to intelligent vehicle navigation systems that provide navigation and emergency services to motor vehicles. As used herein, the terms “vehicle” and “motor vehicle” may be used interchangeably and synonymously to include any relevant vehicle platform, such as passenger vehicles (e.g., combustion engine, hybrid, full electric, fully and partially autonomous, etc.), commercial vehicles, industrial vehicles, tracked vehicles, motorcycles, off-road and all-terrain vehicles (ATV), watercraft, aircraft, etc. In an example, an intelligent vehicle navigation system includes an in-house or outsourced database or other tangible memory device for storing map data, trip data, vehicle data, driver data, etc. A wireless communications device wirelessly connects one or more motor vehicles with one or more system servers, server-class computers, cloud resources, or other suitable electronic controller devices.

Continuing with the discussion of the preceding example, the system controller(s) is/are programmed to receive path plan data indicative of a desired route for the motor vehicle and identify, from a memory-stored map database, each area with limited/no wireless connectivity along the desired route. The system controller(s) collect, look-up, or otherwise identify (collectively “receive”) historical trip data indicative of the durations of time to cross each LNC area for a statistically significant number of prior trips across that LNC area; a probability distribution is created for each set of trip durations. The system controller(s) track a no-signal time lapse, during which a wireless signal is not received from the motor vehicle, after the vehicle's last output of a wireless signal concurrent with the vehicle's entry into the LNC area. A possible driving incident is flagged if the no-signal time lapse exceeds a predefined threshold within the probability distribution; responsive to the likely occurrence of a driving incident, the controller(s) transmit one or more alerts to remote computing nodes of one or more third-party entities.

For any of the disclosed systems, vehicles, and methods, determining a probability distribution for the trip durations may include: using a probability density function of the trip durations to construct a normal-type continuous probability distribution, which includes a center expected value and a predefined number of standard deviations; setting the center expected value as an arithmetic mean of the trip durations; and setting the predefined threshold as one of the standard deviations from the center expected value. A second predefined threshold may be set as another one of the standard deviations; if the no-signal time lapse exceeds this second predefined threshold, the system controller may transmit an emergency message to a first-responder entity proximate the LNC area.

For any of the disclosed systems, vehicles, and methods, a user may select one or more user-defined preferences for the desired route via an in-vehicle user-input device. In this instance, a system controller may receive the user-defined preference(s) from a vehicle controller of the motor vehicle and enlarge, contract, or otherwise modify the probability distribution of the trip durations based on the preference(s). For a desired route, a system controller may determine a current time of day, current weather conditions, and/or historical driving behavior of a driver of the motor vehicle. In this instance, the probability distribution may be modified based on the current time of day, current weather conditions, historical driving behavior, etc.

For any of the disclosed systems, vehicles, and methods, the system may receive battery data indicative of a battery state of a battery pack of the motor vehicle and quantify, using the battery data, a risk of battery issues in the LNC area (e.g., loss of charges, TPIM failure, etc.). The predefined threshold(s) may be modified based on the quantified risk of battery issues within the LNC area. The system may predict the motor vehicle's energy consumption from the battery pack while crossing the LNC area; quantifying the risk of battery issues on the LNC area may be further based on the predicted energy consumption. The battery state may include a state of charge (SOC), a state of health (SOH), and/or battery capacity of the battery pack (e.g., the entire pack, a module in the pack, a cell in a module in the pack, etc.). As another option, the historical trip data may include crowd-sourced data of time durations for third-party vehicles to cross the LNC area, host vehicle data of time durations for the motor vehicle to cross the LNC area, and/or open street map data of time durations to cross the LNC area as recorded by a third-party mapping service.

For any of the disclosed systems, vehicles, and methods, the system controller may respond to the no-signal time lapse exceeding a second predefined threshold within the distribution of the trip durations by transmitting an emergency message to a first-responder entity proximate the LNC area. Identifying an LNC area may include: receiving mobile network coverage data indicative of wireless connectivity for multiple track segments on the desired route; determining which, if any, of these track segments has limited/no wireless connectivity; and designating each track segment on the desired route with limited/no wireless connectivity as an LNC area.

For any of the disclosed systems, vehicles, and methods, path plan data may be received via a system controller from a vehicle controller of the motor vehicle responsive to selection of the desired route (choosing an origin, destination, route, etc.) by a user via a user-input device (e.g., touchscreen display, voice command, button panel, smartphone, etc.). Upon receipt of the selected desired route, an activation prompt may be transmitted to the user to enable a driving incident detection protocol; the system controller may then receive a confirmation from the user to enable the driving incident detection protocol. In this instance, transmitting an alert to a remote computing node of a third-party entity is further in response to the user enabling the driving incident detection protocol. Prior to sending the alert to the remote computing node, a no-incident confirmation prompt may be sent to the user to verify a driving incident has not occurred; to avoid a false-positive report, the alert is not transmitted to the third party further in response to the system receiving verification that no incident has occurred within a predefined window of time.

The above summary does not represent every embodiment or every aspect of this disclosure. Rather, the above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes any and all combinations and subcombinations of the elements and features described above and below.

### BRIEF DESCRIPTION OF THE DRAWINGS

FIG. 1 is a partially schematic, side-view illustration of a representative motor vehicle with a network of in-vehicle controllers, sensing devices, and communication devices for networking with an intelligent vehicle navigation system for driving incident detection in low/no connectivity areas according to aspects of the disclosed concepts.

FIG. 2 is a schematic diagram of a representative intelligent vehicle navigation system with driving incident detection capabilities for low/no connectivity areas in accord with aspects of the disclosed concepts.

FIG. 3 is a flowchart illustrating a representative driving incident detection protocol for operating a vehicle navigation system, which may correspond to memory-stored instructions that are executable by a resident or remote controller, control-logic circuit, programmable control unit, or other integrated circuit (IC) device or network of devices in accord with aspects of the disclosed concepts.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover all modifications, equivalents, combinations, subcombinations, permutations, groupings, and alternatives falling within the scope of this disclosure as encompassed, for instance, by the appended claims.

### DETAILED DESCRIPTION

This disclosure is susceptible of embodiment in many forms. Representative examples of the disclosure are shown in the drawings and herein described in detail with the understanding that these embodiments are provided as an exemplification of the disclosed principles, not limitations of the broad aspects of the disclosure. To that end, elements and limitations that are described, for example, in the Abstract, Introduction, Summary, Description of the Drawings, and Detailed Description sections, but not explicitly set forth in the claims, should not be incorporated into the claims, singly or collectively, by implication, inference, or otherwise. Moreover, the drawings discussed herein may not be to scale and are provided purely for instructional purposes. Thus, the specific and relative dimensions shown in the Figures are not to be construed as limiting.

For purposes of the Detailed Description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and permutations thereof, shall each mean “including without limitation.” Moreover, words of approximation, such as “about,” “almost,” “substantially,” “generally,” “approximately,” and the like, may each be used herein in the sense of “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle, when the vehicle is operatively oriented on a horizontal driving surface.

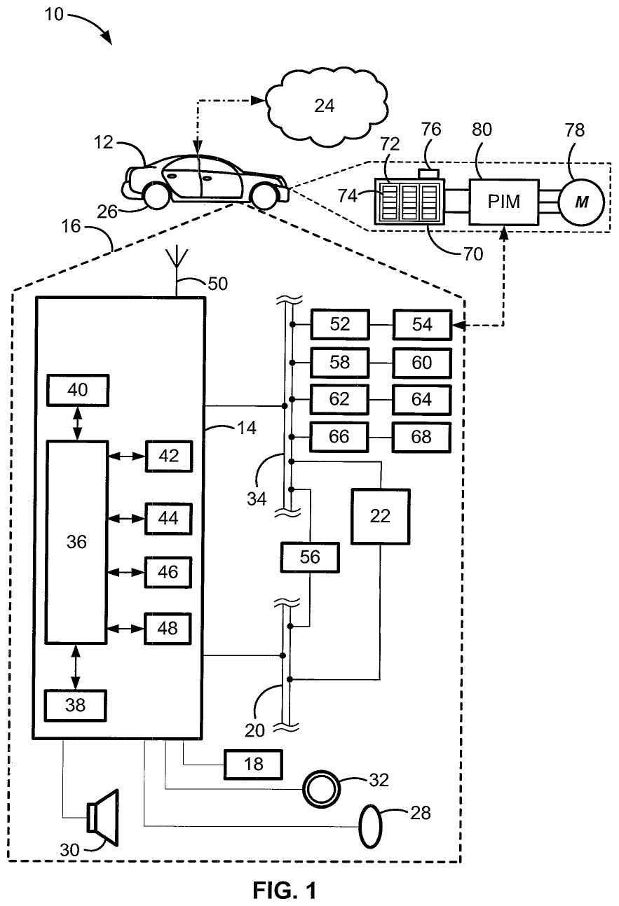

Referring now to the drawings, wherein like reference numbers refer to like features throughout the several views, there is shown in FIG. 1 a representative automobile, which is designated generally at 10 and portrayed herein for purposes of discussion as a sedan-style, electric-drive passenger vehicle. The illustrated automobile 10—also referred to herein as “motor vehicle” or “vehicle” for short—is merely an exemplary application with which novel aspects of this disclosure may be practiced. In the same vein, incorporation of the present concepts into an all-electric vehicle powertrain should also be appreciated as a non-limiting implementation of disclosed features. As such, it will be understood that aspects and features of this disclosure may be applied to other powertrain architectures, may be implemented for any logically relevant type of vehicle, and may be provisioned by other system architectures. Moreover, only select components of the motor vehicles and vehicle control systems are shown and described in additional detail herein. Nevertheless, the vehicles and vehicle systems discussed below may include numerous additional and alternative features, and other available peripheral components, for carrying out the various methods and functions of this disclosure.

The representative vehicle 10 of FIG. 1 is originally equipped with a vehicle telecommunication and information (“telematics”) unit 14 that wirelessly communicates, e.g., via cell towers, base stations, mobile switching centers, satellite service, etc., with a remotely located or “off-board” cloud computing host service 24 (e.g., ONSTAR®). Some of the other vehicle hardware components 16 shown generally in FIG. 1 include, as non-limiting examples, an electronic video display device 18, a microphone 28, audio speakers 30, and assorted input controls 32 (e.g., buttons, knobs, pedals, switches, touchpads, joysticks, touchscreens, etc.). These hardware components 16 function, in part, as a human/machine interface (HMI) to enable a user to communicate with the telematics unit 14 and other system components within the vehicle 10. Microphone 28 provides a vehicle occupant with means to input verbal or other auditory commands; the vehicle 10 may be equipped with an embedded voice-processing unit utilizing audio filtering, editing, and analysis modules. Conversely, the speaker(s) 30 provide audible output to a vehicle occupant and may be either a stand-alone speaker dedicated for use with the telematics unit 14 or may be part of an audio system 22. The audio system 22 is operatively connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switch, parallel/serial communications bus, local area network (LAN) interface, controller area network (CAN) interface, media-oriented system transfer (MOST) interface, local interconnection network (LIN) interface, and the like. Other appropriate communication interfaces may include those that conform with ISO, SAE, and/or IEEE standards and specifications. The network connection interface 34 enables the vehicle hardware 16 to send and receive signals with one another and with various systems and subsystems both within or “resident” to the vehicle body 12 and outside or “remote” from the vehicle body 12. This allows the vehicle 10 to perform various vehicle functions, such as modulating powertrain output, governing operation of the vehicle's transmission, selectively engaging the friction and regenerative brake systems, controlling vehicle steering, regulating charge and discharge of the vehicle's battery modules, and other automated driving functions. For instance, telematics unit 14 receives and transmits signals and data to/from a Powertrain Control Module (PCM) 52, an Advanced Driver Assistance System (ADAS) module 54, an Electronic Battery Control Module (EBCM) 56, a Steering Control Module (SCM) 58, a Brake System Control Module (BSCM) 60, and assorted other vehicle ECUs, such as a transmission control module (TCM), engine control module (ECM), Sensor System Interface Module (SSIM), etc.

With continuing reference to FIG. 1, telematics unit 14 is an onboard computing device that provides a mixture of services, both individually and through its communication with other networked devices. This telematics unit 14 is generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, flash memory, semiconductor memory (e.g., various types of RAM or ROM), etc.

Long-range vehicle communication capabilities with remote, off-board networked devices may be provided via one or more or all of a cellular chipset/component, a navigation and location chipset/component (e.g., global positioning system (GPS) transceiver), or a wireless modem, all of which are collectively represented at 44. Close-range wireless connectivity may be provided via a short-range wireless communication device 46 (e.g., a BLUETOOTH® unit or near field communications (NFC) transceiver), a dedicated short-range communications (DSRC) component 48, and/or a dual antenna 50. It should be understood that the vehicle 10 may be implemented without one or more of the above listed components or, optionally, may include additional components and functionality as desired for a particular end use. The various communication devices described above may be configured to exchange data as part of a periodic broadcast in a vehicle-to-vehicle (V2V) communication system or a vehicle-to-everything (V2X) communication system, e.g., Vehicle-to-Infrastructure (V2I), Vehicle-to-Pedestrian (V2P), Vehicle-to-Device (V2D), etc.

CPU 36 receives sensor data from one or more sensing devices that use, for example, photo detection, radar, laser, ultrasonic, optical, infrared, or other suitable technology for executing an automated driving operation, including short range communications technologies such as DSRC or Ultra-Wide Band (UWB). In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion and analysis hardware and software for processing raw sensor data. The type, placement, number, and interoperability of the distributed array of in-vehicle sensors may be adapted, singly or collectively, to a given vehicle platform for achieving a desired level of autonomous vehicle operation.

Digital camera 62 may use a charge coupled device (CCD) sensor or other suitable optical sensor to generate images indicating a field-of-view of the vehicle 10, and may be configured for continuous image generation, e.g., at least about 35+ images per second. By way of comparison, range sensor 64 may emit and detect reflected radio, infrared, light-based or other electromagnetic signals (e.g., short-range radar, long-range radar, EM inductive sensing, Light Detection and Ranging (LIDAR), etc.) to detect, for example, presence, geometric dimensions, and/or proximity of a target object. Vehicle speed sensor 66 may take on various forms, including wheel speed sensors that measure wheel speeds, which are then used to determine real-time vehicle speed. In addition, the vehicle dynamics sensor 68 may be in the nature of a single-axis or a triple-axis accelerometer, an angular rate sensor, an inclinometer, etc., for detecting longitudinal and lateral acceleration, yaw, roll, and/or pitch rates, or other dynamics related parameters. Using data from the sensing devices 62, 64, 66, 68, the CPU 36 identifies surrounding driving conditions, determines roadway characteristics and surface conditions, identifies target objects within a detectable range of the vehicle, determines attributes of the target object, such as size, relative position, distance, angle of approach, relative speed, etc., and executes automated control maneuvers based on these executed operations.

To propel the electric-drive vehicle 10, an electrified powertrain is operable to generate and deliver tractive torque to one or more of the vehicle's road wheels 26. The powertrain is generally represented in FIG. 1 by a rechargeable energy storage system (RESS), which may be in the nature of a chassis-mounted traction battery pack 70, that is operatively connected to an electric traction motor 78. The traction battery pack 70 is generally composed of one or more battery modules 72 each having a stack of battery cells 74, such as lithium ion, lithium polymer, or nickel metal hydride battery cells of the pouch, can, or prismatic type. One or more electric machines, such as traction motor/generator (M) units 78, draw electrical power from and, optionally, deliver electrical power to the RESS's battery pack 70. A dedicated power inverter module (PIM) 80 electrically connects the battery pack 70 to the motor/generator (M) unit(s) 78 and modulates that transmission of electrical current therebetween.

The battery pack 70 may be configured such that module management, cell sensing, and module-to-module or module-to-host communication functionality is integrated directly into each battery module 72 and performed wirelessly via a wireless-enabled cell monitoring unit (CMU) 76. The CMU 76 may be a microcontroller-based, printed circuit board (PCB)-mounted sensor array. Each CMU 76 may have a GPS transceiver and RF capabilities and may be packaged on or in a battery module housing. The battery module cells 74, CMU 76, housing, coolant lines, busbars, etc., collectively define the cell module assembly.

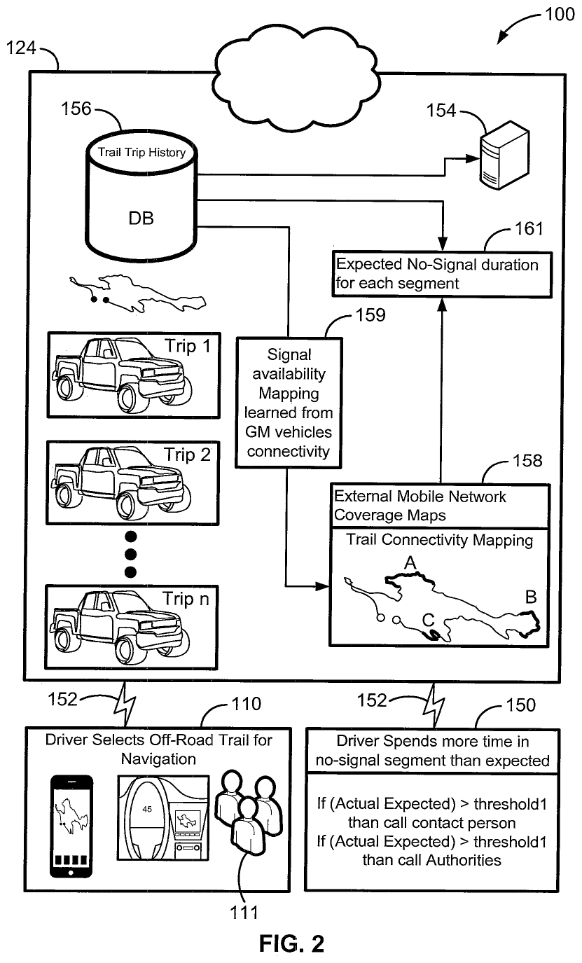

Presented in FIG. 2 is a schematic diagram of an exemplary intelligent vehicle navigation (IVN) system 100 for provisioning, among other features, navigation and emergency services for a distributed network of vehicles. While illustrating a single cloud computing host service 124 communicating with a single motor vehicle 110 and a single third-party entity 150, it is envisioned that any number of host computing services (e.g., cloud, edge, distributed, serverless, etc.) may communicate with any number of vehicles and any number of third-party entities and their associated computing nodes that are suitably equipped for wirelessly exchanging information and data. Although differing in appearance, it is envisioned that any of the features and options described above with reference to the automobile 10 and host service 24 of FIG. 1 can be incorporated, singly or in any combination, into the motor vehicle 110 and cloud computing host service 124 of FIG. 2, respectively, and vice versa.

The cloud computing host service 124 of FIG. 2 communicatively connects to each motor vehicle 110 and each third-party entity 140 via a wireless communications network 38 (e.g., as discussed above with respect to telematics unit 14 of FIG. 1). Wireless data exchanges between the vehicle 110 and host service 124 may be conducted directly—in configurations in which the vehicle 110 is equipped as a standalone wireless device—or indirectly—by pairing and piggy backing the vehicle 110 onto a wireless-enabled device, such as a smartphone, smartwatch, handheld GPS transceiver, laptop, etc. It is also envisioned that the host service 124 may communicate directly with a personal computing device of a driver or occupant of vehicle 110 and, thus, forego or supplement direct communications with the vehicle 110. As yet a further option, many of the services provided by host service 124 may by onboarded to the motor vehicle 110.

With continuing reference to FIG. 2, the host system 124 may be implemented through a high-speed, server-class computing device 154 or a mainframe computer capable of handling bulk data processing, resource planning, and transaction processing. For instance, the host system 124 may operate as the host in a client-server interface for conducting any necessary data exchanges and communications with one or more “third party” servers or devices to complete a particular transaction. Alternatively, the cloud computing host system 124 may operate as middleware for IoT (Internet of Things), WoT (Web of Things), vehicle-to-everything (V2X), and/or M2M (machine-to-machine) services, e.g., connecting an assortment of heterogeneous devices with a service-oriented architecture (SOA) via a data network. As an example, cloud computing host system 124 may be implemented as a middleware node to provide different functions for dynamically onboarding heterogeneous devices, multiplexing data from each of these devices, and routing the data through reconfigurable processing logic for processing and transmission to one or more destination applications. Network 152 may be any available type of network, including a combination of public distributed computing networks (e.g., Internet) and secured private networks (e.g., local area network, wide area network, virtual private network). It may also include wireless and wireline transmission systems (e.g., satellite, cellular tower network, terrestrial networks, etc.). In at least some aspects, most if not all data transaction functions carried out by the system 100 may be conducted over a wireless network, such as cellular data network in conjunction with a wireless local area network (WLAN), to ensure freedom of movement of the vehicle 110.

In accord with the illustrated example, an occupant 111 of vehicle 124 selects a desired route for navigation during an upcoming or future trip. This may include the driver selecting a route on an off-road trail or remote roadway via a personal smartphone, in-vehicle telematics unit, or center-stack input controls. Route selection may merely necessitate the driver select a desired destination; predicated path plan data may then be generated by navigation software embedded within an onboard vehicle navigation system from the selected destination and geolocation data of the vehicle's current location. For autonomous vehicles, such as an SAE Level 3, 4 or 5 vehicle, desired route information may originate solely from the vehicle's advanced driver assistance system (ADAS) module or automated vehicle control (AVC) module.

Route selection data is then transmitted wirelessly over network 152 to the cloud computing host service 124. In accord with the illustrated example, a server-class computer 154 of the IVN system 100 processes the path plan data to evaluate routing information for the desired route contained therein or, if only provided with vehicle origin and destination information, generate or retrieve a desired route with associated routing information for the vehicle 110. Server-class computer 154 may access a memory-stored map database, e.g., retrieved from an external open street map service 158 or from a database (DB) 156 using dedicated database management system (BDMS) software, to pull map data and identify what, if any, segments on the desired route are low/no-connectivity (LNC) areas with limited or no wireless connectivity. Wireless connectivity data for a desired route may be sourced from a third-party vendor, as described above, or may be collected by the IVN system 100, as described below.

To pinpoint an LNC area, the navigation system 100 may collect mobile network coverage data 159 containing wireless connectivity information for multiple track segments on a select route. Mobile network coverage data 159 may be retrieved directly from one or more local cellular towers, sourced from the responsible mobile carrier(s) in that region, and/or aggregated from crowd-sourced participating vehicles. From this information, the IVN system computer 154 learns which of the track segments on the desired route, if any, has limited or no wireless connectivity. For at least some implementations, wireless service with a signal strength of less than −90 decibel milliwatts (dBm) may be deemed limited/no connectivity. By way of non-limiting example, a signal strength of −30 may be designated as a “perfect signal” and −50 dBm is a strong signal, whereas −95 dBm is a very weak signal and −110 dBm is considered no signal). Each of the route track segments with limited/no connectivity may be designated as an LNC area.

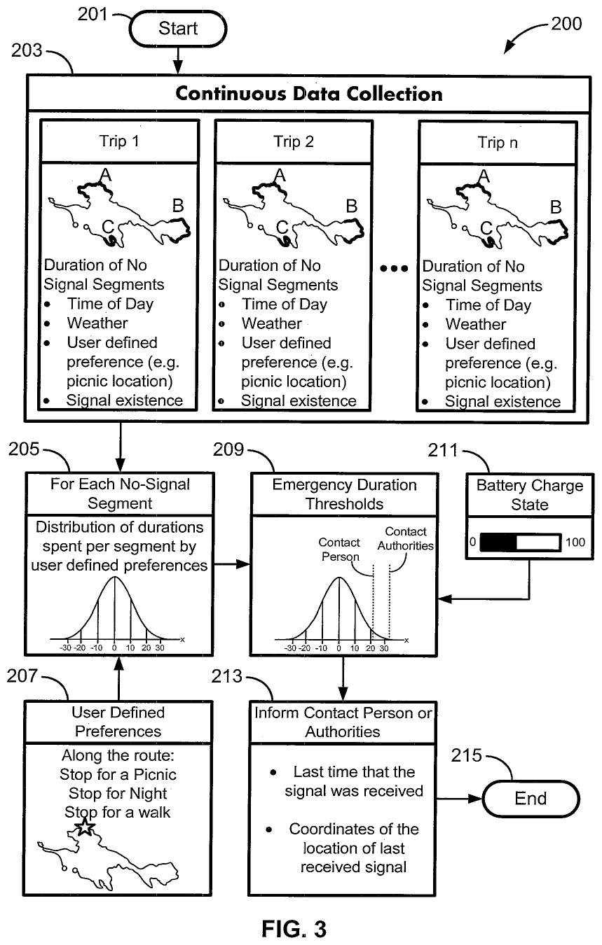

After identifying which segment or segments of the desired route that have limited/no connectivity, the IVN system 100 derives an expected “no-signal” duration 161 for each LNC area. As shown, TRAIL TRIP HISTORY data (described further below in the discussion of FIG. 3) may be amassed by the database 156 to determine a respective duration or time (also referred to herein as “trip duration”) to cross a particular LNC area. Historical trip data may encompass, as non-limiting examples, crowd-sourced data containing time durations for third-party vehicles to cross the LNC area during past trips, host vehicle data of time durations for the subject host vehicle to cross the LNC area during past trips, and/or open street map data of time durations to cross the LNC area recorded by a third-party mapping service. For some implementations, the IVN system 100 may monitor and record wireless signal output from a random set or a select set of vehicles when those vehicles are entering and exiting an LNC area and, optionally, when crossing through an LNC area. From this data, the system 100 ascertains a duration of time without receiving a signal—between a last “terminus” signal upon entry and a next “inception” signal upon exit—for each vehicle when traversing the no-signal segment. After completion of an initial learning phase, i.e., when the system 100 has accumulated a sufficiently sized data set for a meaningful distribution, a mathematical probability distribution is created across most or all monitored vehicles that drove through this segment. This information is used to determine if and when to alert a third-party entity of a likely driving incident, as indicated at 150 in FIG. 2.

With reference next to the flow chart of FIG. 3, an improved method or control strategy for driving incident detection for a host vehicle, such as vehicle 10 of FIG. 1, using an intelligent navigation system, such as IVN system 100 of FIG. 2, is generally described at 200 in accordance with aspects of the present disclosure. Some or all of the operations illustrated in FIG. 3, and described in further detail below, may be representative of an algorithm that corresponds to processor-executable instructions that are stored, for example, in main or auxiliary or remote memory (e.g., memory device 38 of FIG. 1 and/or database 156 of FIG. 2), and executed, for example, by an electronic controller, processing unit, logic circuit, or other module or device or network of modules/devices (e.g., CPU 36 and/or cloud computing service 124 of FIG. 2), to perform any or all of the above and below described functions associated with the disclosed concepts. It should be recognized that the order of execution of the illustrated operation blocks may be changed, additional operation blocks may be added, and some of the described operations may be modified, combined, or eliminated.

Method 200 of FIG. 3 begins at START terminal block 201 with memory-stored, processor-executable instructions for a programmable controller or control module or similarly suitable processor to call up an initialization procedure for an off-road emergency detection protocol. This routine may be executed in real-time, near real-time, continuously, systematically, sporadically, and/or at regular intervals, for example, each 10 or 100 milliseconds during normal and ongoing operation of the motor vehicle 10. As yet another option, terminal block 201 may initialize responsive to a user command prompt, a resident vehicle controller prompt, or a broadcast prompt signal received from an “off-board” centralized vehicle services system (e.g., host cloud computing service 24). Upon completion of the control operations presented in FIG. 3, the method 200 may advance to END terminal block 215 and temporarily terminate or, optionally, may loop back to terminal block 201 and run in a continuous loop.

Advancing from terminal block 201, the method 200 executes a CONTINUOUS DATA COLLECTION data input block 203 to collect trip data for the off-road emergency detection protocol. As mentioned above, the TRAIL TRIPS HISTORY database 156 may aggregate, filter, analyze, and categorize crowd-sourced trip information, host-vehicle trip information, vehicle-specific trip information (e.g., for vehicles with the same make, model, trim package, etc., as host vehicle), trip information supplied by a subscription-based mapping platform, etc. IVN system 100 of FIG. 2, for example, may employ a learning system methodology that continuously collects data for each segment of a given route, monitoring the following elements: location(s) of signal loss; location(s) of signal resumption; time duration between each signal loss/resumption; time of day associated with each loss/resumption/duration set; weather associated with each loss/resumption/duration set; etc. When available, the IVN system 100 may also identify user-defined preferences and/or user-specific driving behaviors for each trip or trip segment. Trip-specific data, such as user-defined preferences, weather, time of day, driver behavior, vehicle make/model, signal existence, etc., may be used for categorizing the associated trip data so that the data is organized for retrieval to more accurately reflect the real-world circumstances of a desired route to which they are matched. For instance, if the desired route will take place midday, in the rain, by an SUV with a driver known to be aggressive, the system will attempt to focus its evaluation on comparable prior trips that were also midday/rainy/SUV/aggressive driver.

After retrieving related trip data for a select LNC area on a desired route, method 200 executes NO-SIGNAL DURATION DISTRIBUTION predefined process block 205 to determine a probability distribution of the historical trip durations for that select LNC area. A probability distribution may be constructed as a normal-type continuous (Gaussian) distribution using a probability density function with trip duration as the real-valued random variable. The resultant distribution will have a center expected value (μ) and a predefined number of standard deviations (σ), typically two or three standard deviations. The center expected value (μ) may be defined as an arithmetic mean of the trip durations from the associated data set. A first predefined threshold for the probability distribution of trip durations may be set as an absolute value of a first of the standard deviations (e.g., about 2σ in FIG. 3). Likewise, a second predefined threshold may be set as an absolute value of a second of the standard deviations (e.g., about 3σ). It should be appreciated that the recitation of “a first” or “a second” of the standard deviations does not imply one SD and two SD, respectively, but rather one threshold value correlated with one of the available SDs and another threshold value correlated with another SD.

To help ensure a meaningful distribution, the probability distribution may necessitate a statistically significant number of prior trips across each LNC area. Statistical significance may be typified by a set of data of a size sufficient to ensure a determination that the results of the data set are not explainable by or reasonably attributed to random factors or chance alone. Statistical hypothesis testing can be used to make this determination; this test produces a critical p-value that is indicative of a probability of obtaining the observed data result(s) if the null hypothesis were true (i.e., there is no significant relationship between variables). A data set with a p-value of 5% or lower (i.e., <0.05) is often considered to be statistically significant as it indicates strong evidence against the null hypothesis, as there is less than a 5% probability the results are random. The “significance test” may be made more stringent, for example, by moving the p-value threshold to 0.02 (2%) or less stringent by moving it to 0.08 (8%), but typically no less than 0.10 (10%).

With continuing reference to FIG. 3, a USER-DEFINED PREFERENCE data input block 207 retrieves user-defined preferences for a driver of the subject host vehicle; these user-defined driver preferences may be fed into predefined process block 205 to more accurately estimate the time to cross a particular LNC area. User-defined driver preferences may include, singly and in any combination, the following activities: stop for picnic; stop for night; stop for walk; rest stop; stop for [other activity]; slow vehicle speed [for specified or non-specified reason]; increase vehicle speed [for specified or non-specified reason]; other. Prior to starting a desired route and/or entering an LNC area, a user may be prompted to select one or more pre-defined activities for one or more locations on the route. Before starting a desired route, for example, a user may input a selection notifying the IVN system 100 the intent to have a picnic in a location that is on a no-signal segment. Based on collected historic data, the IVN system 100 may generate a distribution of durations in this no-signal segment using only data in which users notified that they were likewise having/had a picnic. Alternatively, if a driver intends to stop for a walk, the IVN system 100 may add a predefined buffer to the estimated trip duration (e.g., 2-hour delay added to shift distribution). As yet a further option, if a driver intends to camp out overnight on a designated LNC area, the IVN system 100 may either create a distribution of durations using only similar trip history data with a corresponding delay or, for instances in which there are limited/no prior trips with a corresponding delay, add a larger predefined buffer (e.g., 18-hour delay added to shift distribution).

After creation of a probability distribution (block 205) and any associated modifications thereof based on user-selected preferences (block 207), method 200 advances to EMERGENCY DURATION THRESHOLDS predefined process block 209 to determine one or more predefined thresholds for predicting the occurrence of a driving incident. As indicated above, each predefined threshold for a probability distribution of trip durations may be associated with a respective one of the standard deviations. In FIG. 3, a first CONTACT PERSON threshold is approximately equal to the second standard deviation (e.g., about 22 mins) and a second CONTACT AUTHORITIES threshold is approximately equal to the third standard deviation (e.g., about 33 mins). These thresholds may be calibrated to the make/model/trim of the subject host vehicle, for example, based on vehicle test/emulation data. For at least some implementations, these thresholds may be varied based on a user-defined risk tolerance (e.g., lower thresholds for risk-averse drivers), which may be input by any of the above-described user-input devices.

IVN system 100 may also account for vehicle battery state upon entry into an LNC area in order to modify the size of each time delay interval for informing contact personnel/local authorities. In the illustrated example, method 200 executes BATTERY CHARGE STATE input block 211 to retrieve battery state data that is indicative of a battery state of the subject host vehicle. This battery state may include, singly or in any combination, a real-time or near real-time state of charge (SoC), state of health (SoH), operating temperature, capacity, etc., for a battery pack, a module in a pack, and/or a cell in a module in a pack. Using this information, the IVN system 100 may modify one or more of the predefined thresholds within the probability distribution based on the forecasted risk of a battery issue while crossing a low/no connectivity segment. For instance, a first driver may enter an LNC segment with a 30% SOC, while a second driver enters the same LNC segment with a 80% SOC. Based on historical trip data, the IVN system 100 may predict that the energy consumption for this segment is a distribution centered around 25% of the battery. Consequently, the system 100 may determine that the first driver with the low SOC will likely have a battery issue—a high probability (e.g., >90%) of running out of power—whereas the second driver with the high SOC will likely not have a battery issue (e.g., <15%). In this instance, both predefined thresholds within the probability distribution may be reduced by a predefined threshold reduction for the first driver; the predefined thresholds for the second driver may remain unaffected. Predicted energy consumption along a given low/no connectivity area may be based on the length of the LNC area, the conditions of the roadway along the LNC area, historical data of the host vehicle's energy consumption, historical data of similar make/model/trim energy consumption, etc.

Once the thresholds are set, method 200 may advance from predefined process block 209 to INFORM CONTACT OR AUTHORITIES predefined process block 213. For this operation, the IVN system may track a “no-signal” time lapse for the subject host vehicle, namely a period of time in which no signal is received from the host after output of the last wireless signal by the host prior to/during entry into an LNC area. For instance, the IVN system 100 may systematically ping the subject host vehicle for a cellular signal after a predefined time lapse of not receiving a signal from the host concurrent with the host approaching/entering an LNC area. Alternatively, the IVN system 100 may communicate with a local mobile carrier (e.g., 4G/LTE/5G) to ascertain the connectivity status of the host.

IVN system 100 may predict the occurrence of a driving incident responsive to a determination that the no-signal time lapse has exceeded at least one predefined threshold within the trip duration probability distribution. Referring once again to the illustrated example, if the no-signal time lapse for the host vehicle has exceeded the first (22 min) threshold, the IVN computing device 154 may responsively transmit an electronic alert to a remote computing node of a third-party entity. This may include a system-automated text, email, phone call, etc., being sent to a designated contact person of a driver of the host vehicle. If the no-signal time lapse for the host vehicle has exceeded the second (33 min) threshold, the IVN computing device 154 may responsively transmit an electronic alert to a remote computing node of another third-party entity. This may include a system-automated emergency message being sent to a first-responder proximate the LNC area, such as a local 911 dispatch, fire department, police department, etc. Prior to sending either of the aforementioned alerts/messages, the IVN system 100 may first attempt to contact the driver of the host vehicle to determine if a driving incident has in-fact occurred. To militate against a false-positive report, it is also envisioned that the driver may actively disable the driving incident detection protocol and, thus, prevent any corresponding transmission of the alerts/messages.

For at least some embodiments, a user may be prompted to define a designated contact person who will be automatically alerted and/or periodically updated by the system during poor connectivity segments of a desired route. For example, a designated contact person may receive to a dedicated mobile app operating on his/her smartphone a report with current signal quality information, when and where the system estimates the user will have a minimum level of signal quality, when and where the last signal was received from the user/vehicle, the battery state before entering a LNC area, etc. The report may also contain “richer” information, including a sequence of images or video footage of the trail or LNC area(s), a vehicle dynamics report (e.g., speed, acceleration, etc.), a risky driving score, etc. A report with some or all of the aforementioned information may also be submitted to emergency personnel for situation tracking. With larger (or smaller) delays of the user signal response as compared to the expected timing, the frequency of the reports/messages to the contact/emergency personnel may increase (or decrease). The system may also work offline, for example, by downloading the relevant information before the host vehicle enters an LNC area. Users may decide whether the system will be active or not from the corresponding map of the desired route.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method for controlling operation of an intelligent vehicle navigation system communicating with a motor vehicle, the method comprising:
receiving, via a system controller through a wireless communications device, path plan data indicative of a desired route for the motor vehicle;
identifying, via the system controller from a memory-stored map database, a low/no-connectivity (LNC) area with limited or no wireless connectivity within the desired route;
receiving historical trip data indicative of trip durations to cross the LNC area for a statistically significant number of prior trips across the LNC area;
determining a probability distribution of the trip durations;
tracking a no-signal time lapse after output of a last wireless signal by the motor vehicle concurrent with entry of the motor vehicle into the LNC area;
predicting occurrence of a driving incident responsive to the no-signal time lapse exceeding a predefined threshold within the probability distribution of the trip durations; and
transmitting, via the system controller responsive to predicting the occurrence of the driving incident, an alert to a remote computing node of a third-party entity.

2. The method of claim 1, wherein determining the probability distribution of the trip durations includes:
constructing a normal distribution, including a center expected value and a predefined number of standard deviations, using a probability density function of the trip durations;
setting the center expected value as an arithmetic mean of the trip durations; and
setting the predefined threshold as a first of the standard deviations.

3. The method of claim 2, further comprising:
setting a second predefined threshold as a second of the standard deviations; and
transmitting, via the system controller responsive to the no-signal time lapse exceeding the second predefined threshold, an emergency message to a first-responder entity proximate the LNC area.

4. The method of claim 1, further comprising:
receiving, via the system controller from a vehicle controller of the motor vehicle, a user-defined preference for the desired route selected by a user via an in-vehicle user-input device; and
modifying the probability distribution of the trip durations based on the user-defined preference.

5. The method of claim 4, further comprising:
determining, for the desired route, a current time of day, current weather conditions, and/or historical driving behavior of a driver of the motor vehicle; and
modifying the probability distribution of the trip durations based on the current time of day, the current weather conditions, and/or the historical driving behavior of the driver.

6. The method of claim 1, further comprising:
receiving battery data indicative of a battery state of a battery pack of the motor vehicle;
quantifying a risk of battery issues on the LNC area based on the battery data; and
modifying the predefined threshold based on the quantified risk of battery issues on the LNC area.

7. The method of claim 6, further comprising predicting an energy consumption of the motor vehicle from the battery pack while crossing the LNC area, wherein quantifying the risk of battery issues on the LNC area is further based on the predicted energy consumption.

8. The method of claim 6, wherein the battery state includes a state of charge (SOC), a state of health (SOH), and/or battery capacity of the battery pack.

9. The method of claim 1, further comprising transmitting, via the system controller responsive to the no-signal time lapse exceeding a second predefined threshold within the distribution of the trip durations, an emergency message to a first-responder entity proximate the LNC area.

10. The method of claim 1, wherein identifying the LNC area includes:
receiving mobile network coverage data indicative of wireless connectivity for multiple track segments on the desired route;
determining which of the track segments on the desired route, if any, has limited or no wireless connectivity; and
designating the LNC area as at least one of the track segments on the desired route having limited or no wireless connectivity.

11. The method of claim 1, wherein the path plan data is received via the system controller from a vehicle controller of the motor vehicle responsive to selection of the desired route by a user via a user-input device connected to the vehicle controller.

12. The method of claim 11, further comprising:
transmitting, responsive to receipt of the selection of the desired route by the user, an activation prompt to the user to enable a driving incident detection protocol; and
receiving, via the system controller from the vehicle controller of the motor vehicle, a confirmation input by the user to enable the driving incident detection protocol,
wherein transmitting the alert to the remote computing node of the third-party entity is further in response to the user enabling the driving incident detection protocol.

13. The method of claim 1, further comprising:
transmitting, prior to sending the alert to the remote computing node, a no-incident confirmation prompt to the user to verify a driving incident has not occurred in the LNC area,
wherein transmitting the alert to the remote computing node of the third-party entity is further in response to not receiving the verification of the no-incident confirmation prompt within a predefined window of time.

14. The method of claim 1, wherein the historical trip data includes crowd-sourced data of time durations for third-party vehicles to cross the LNC area, host vehicle data of time durations for the motor vehicle to cross the LNC area, and/or open street map data of time durations to cross the LNC area recorded by a third-party mapping service.

15. An intelligent vehicle navigation system, comprising:
a memory device storing trip data;
a wireless communications device operable to wirelessly communicate with a motor vehicle; and
a system controller operatively connected to the memory device and the wireless communications device, the system controller being programmed to:
receive path plan data indicative of a desired route for the motor vehicle;
identify, from a memory-stored map database, a low/no-connectivity (LNC) area with limited or no wireless connectivity within the desired route;
receive, from the memory device, historical trip data indicative of trip durations to cross the LNC area for a statistically significant number of prior trips across the LNC area;
determine a probability distribution of the trip durations;
track a no-signal time lapse, during which no wireless signal is received from the motor vehicle, after output of a last wireless signal by the motor vehicle concurrent with entry of the motor vehicle into the LNC area;
predict occurrence of a driving incident responsive to the no-signal time lapse exceeding a predefined threshold within the probability distribution; and
responsive to predicting the occurrence of the driving incident, transmit an alert to a remote computing node of a third-party entity.

16. The intelligent vehicle navigation system of claim 15, wherein determining the probability distribution of the trip durations includes:
constructing a normal distribution, including a center expected value and a predefined number of standard deviations, using a probability density function of the trip durations;
setting the center expected value as an arithmetic mean of the trip durations; and
setting the predefined threshold as a first of the standard deviations.

17. The intelligent vehicle navigation system of claim 16, wherein the system controller is further programmed to:
set a second predefined threshold as a second of the standard deviations; and
transmit, via the system controller responsive to the no-signal time lapse exceeding the second predefined threshold, an emergency message to a first-responder entity proximate the LNC area.

18. The intelligent vehicle navigation system of claim 15, wherein the system controller is further programmed to:
receive a user-defined preference for the desired route selected by a user via an in-vehicle user-input device; and
modify the probability distribution of the trip durations based on the user-defined preference.

19. The intelligent vehicle navigation system of claim 15, wherein the system controller is further programmed to:
determine, for the desired route, a current time of day, current weather conditions, and/or historical driving behavior of a driver of the motor vehicle; and
modify the probability distribution of the trip durations based on the current time of day, the current weather conditions, and/or the historical driving behavior of the driver.

20. The intelligent vehicle navigation system of claim 15, wherein the system controller is further programmed to:
determine a battery state of a battery pack of the motor vehicle;
quantify a risk of battery issues on the LNC area based on the battery state; and
modify the predefined threshold based on the quantified risk of battery issues on the LNC area.
